(19) United States
(12) Patent Application Publication
(10) Pub. No.: US 2009/0232202 A1
(43) Pub. Date: Sep. 17, 2009

(54) WIRELESS VIDEO STREAMING USING SINGLE LAYER CODING AND PRIORITIZED STREAMING

(75) Inventors: Richard Y. Chen, Croton-On-Hudson, NY (US); Yingwei Chen, Briarcliff Manor, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,225

(22) PCT Filed: Dec. 8, 2005
(86) PCT No.: PCT/IB05/54140

§ 371 Date: Jun. 8, 2007

Related U.S. Application Data
(60) Provisional application No. 60/635,240, filed on Dec. 10, 2004.

(51) Int. Cl. H04N 7/26; H04N 7/32

(52) U.S. Cl. 375/240.02; 375/240.15; 375/E07.126; 375/E07.244

(57) ABSTRACT

A method of communication includes providing single layer content coded video frames (101-111, 202, 203, 205-208, 210-219). The method also includes selectively assigning each of the video frames to one of a plurality of levels. In addition, the method includes selectively transmitting some or all of the video frames in a prioritized manner based on bandwidth limitations. A video link (500) is also described.

The use of wireless connectivity in communications continues to increase. Devices that benefit from wireless connectivity include portable computers, portable handsets, personal digital assistants (PDAs) and entertainment systems, to name just a few. While advances in wireless connectivity have lead to faster and more reliable communications over the wireless medium, certain technologies have lagged others in both quality and speed. One such technology is video technology.

Because the bandwidth requirements of video signals are comparatively high, video communication can tax the bandwidth limits of known wireless networks. Moreover, the bandwidth of a wireless network may depend on the time of the transmission as well as the location of the transmitter. Furthermore, interference from other wireless stations, other networks, wireless devices operating in the same frequency spectrum as well as other environmental factors can degrade video signals transmitted in a wireless medium.

In addition to the considerations of bandwidth and interference, video signal quality can suffer as a result of loss of data packets. To this end, digital video content is often transmitted in packets of data, which include compressed content that is coded using transform coding with motion prediction. The packets are then transmitted in a stream of packets often referred to as video streaming. However, during transmission, a lost or erroneous video packet can inhibit the decoding process at the receiver.

As is known, drift is caused by the loss of data packets belonging to reference video frames. This loss can prevent a decoder at a receiver site from correctly decoding reference video frames.

Regardless of the source, lost or erroneous packet data that belong to reference video frames can result in the inability to properly reconstruct a number of frames of video subsequent to the erroneous or lost packets. This is known as prediction drift. Prediction drift occurs when the reference video frames used to compensate motion in subsequent frames at the receiver's decoder do not match those used at the coder of the transmitter. Ultimately, this can result in higher distortion in video quality or reduced or unacceptable video quality.

Certain known techniques have been explored to address the problems of varying bandwidth and channel conditions and their impact on video quality. One known technique is known as scalable video content coding technology, which is also known as layered video content coding. These technologies include motion picture enhancement group (MPEG)-2/4 temporal, spatial and SNR scalability, MPEG-4 FGS and data partition and wavelet video coding technologies.

In scalable video coding technology, the video content is compressed and prioritized into bitstreams. In layered video streaming systems that make use of scalable video streaming technologies, the bitstreams are packetized/partitioned into separate sub-bitstreams (layers) having different priorities. If the bandwidth of the wireless channel is insufficient, the content layers may be dropped, allowing the base layers to be transmitted. While the scalable video coding technology provides benefits over known single-layer technologies, many receivers do not include decoders that are compatible with the multi-layer coded video content. Thus, the need remains to improve video transmission with single layer content coding.

What is needed, therefore, is a method and apparatus of wireless communication that overcomes at least the shortcomings of known methods and apparati described above.

In accordance with an example embodiment, a method of communication includes providing single layer content coded video frames. The method also includes selectively assigning each of the video frames to one of a plurality of levels. In addition, the method includes selectively transmitting some or all of the video frames based on bandwidth limitations. In accordance with another example embodiment, a communication link includes a receiver and a transmitter. An encoder is connected to the transmitter and is adapted to encode video signals into a plurality of single layer content coded video frames. In addition, the encoder is adapted to assign each of the video frames to one of a plurality of levels.

The example embodiments are best understood from the following detailed description when read with the accompanying drawing figures. It is emphasized that the various features are not necessarily drawn to scale. In fact, the dimensions may be arbitrarily increased or decreased for clarity of discussion.

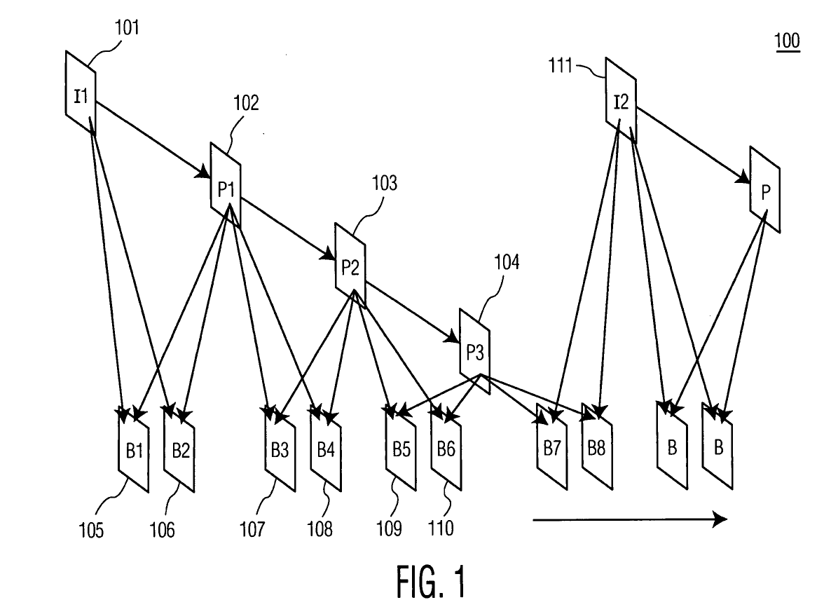

FIG. 1 is a schematic diagram of a dependency tree in accordance with an example embodiment.

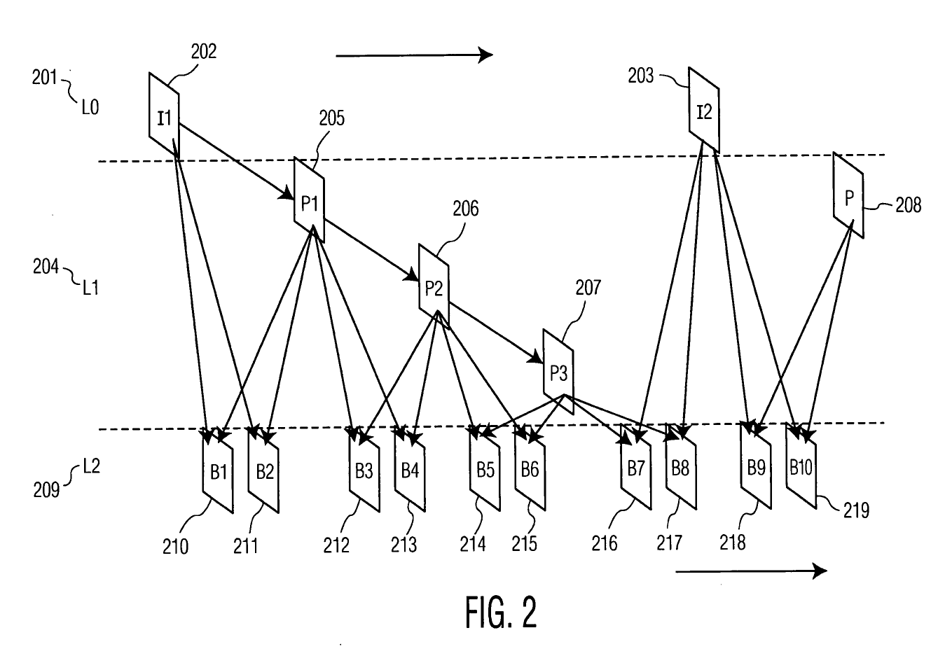

FIG. 2 is a schematic diagram of a dependency tree in accordance with an example embodiment.

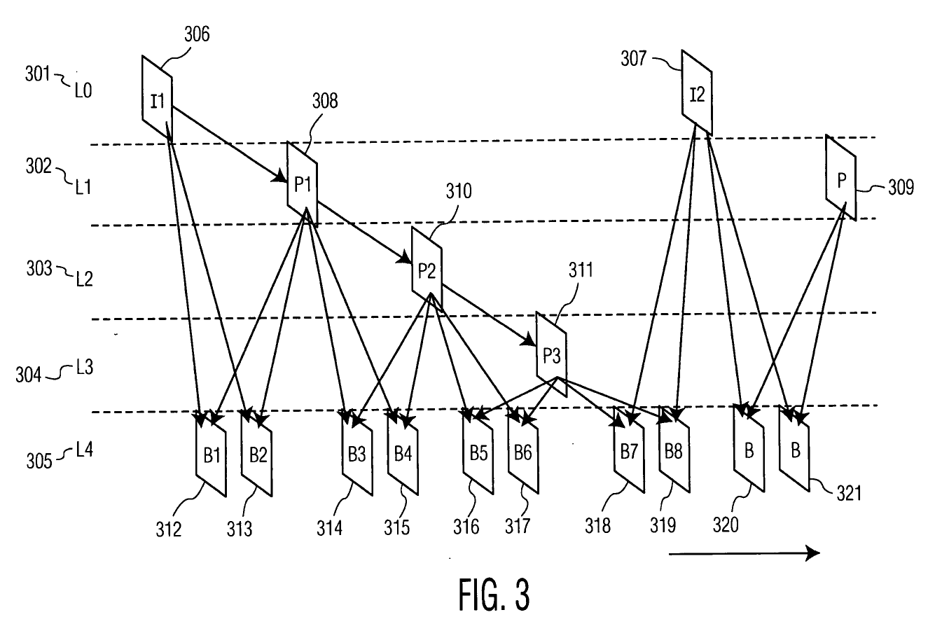

FIG. 3 is a schematic diagram of a dependency tree in accordance with an example embodiment.

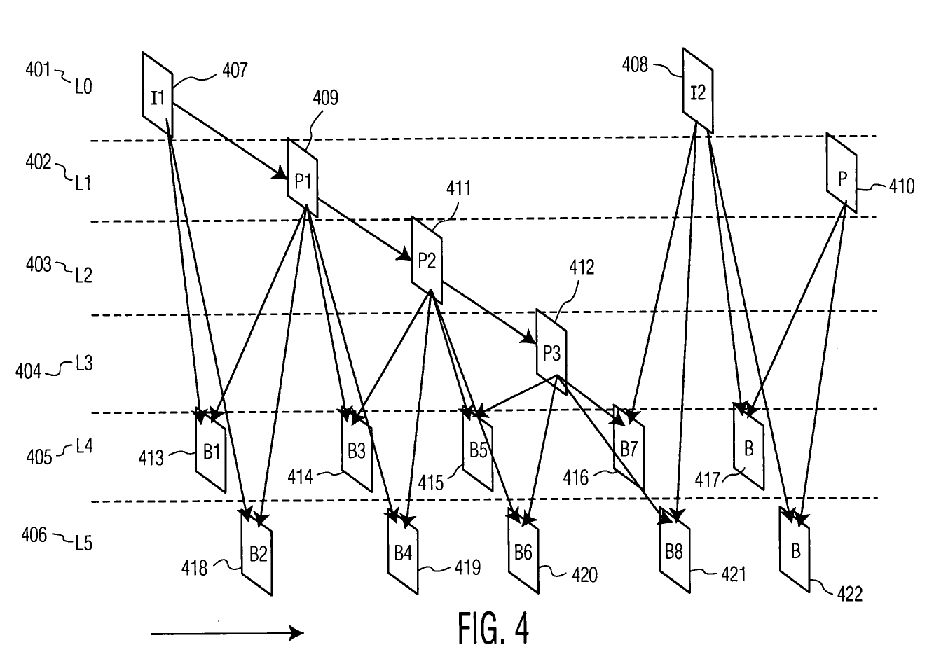

FIG. 4 is a schematic diagram of a dependency tree in accordance with an example embodiment.

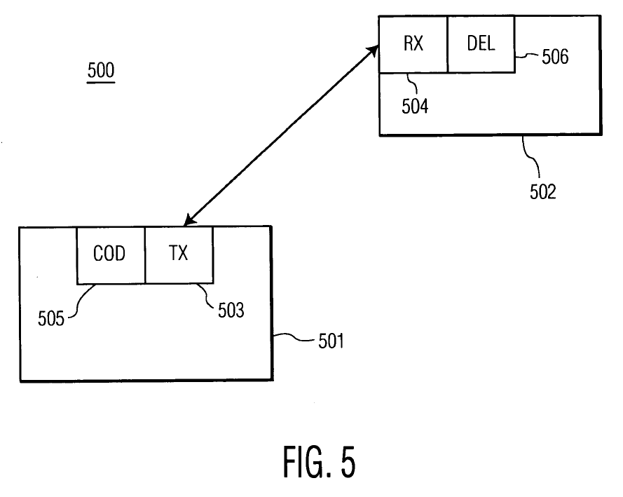

FIG. 5 is a schematic diagram of a wireless video link in accordance with an example embodiment.

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention. Wherever possible, like numerals refer to like features throughout.

Briefly, the example embodiments relate to methods of transmitting and receiving video streams. In example embodiments, the transmission and reception of video streams are over a wireless link. Illustratively, video data are in a single-layer coded video stream that is packetized and arranged in a dependency structure based on priority levels. To with, the single-layer coded video bit stream is prioritized based on dependency on temporally previous frames.

Beneficially, the methods and related apparati substantially prevent prediction-drift in streaming video. Moreover, the methods and related apparati of the example embodiments foster adaptation of video communications in wireless networks having time and location dependent bandwidth. In addition, the methods and related apparati of the example embodiments enable improved streaming video transmission in networks and links having a standard-compliant conventional single-layer decoder. These and other benefits will become clearer to one of ordinary skill in the art as the present description continues.

It is noted that the description of example embodiments include coding of video frames in accordance with known MPEG (or its progeny) or known H.264 techniques. It is noted that these methods are merely illustrative and that other encoding methods are contemplated.

In addition, the wireless link is illustratively in compliance with the IEEE 802.11 protocol, its progeny and proposed amendments. Again, this is merely illustrative and it is contemplated that the methods and apparati of the example embodiments may be used in other wireless systems. For example, the wireless link may be a satellite wireless digital video broadcasting link, including high-definition terrestrial TV. Moreover, the methods and apparati of the example embodiments may be used to effect video transmission over wireless mobile network such as a third generation partnership project (3GPP). It is noted that in addition to wireless links, the methods and apparati of the example embodiment may be used in connection with wired technologies such as video conferencing/videophony over telephone line and broadband IP networks.

Again, it is emphasized that the methods and apparati of the example embodiments may be used in conjunction with still other alternative encoding techniques and wireless protocols; and that these alternatives will be readily apparent to one of ordinary skill in the art, who has had the benefit of the present disclosure.

FIG. 1 is a schematic representation of a dependency tree 100 in accordance with an illustrative embodiment. The tree 100 includes a plurality of frames each including one or more packets encoded via a single-layer motion estimating video coding method, such as MPEG or H.264.

As will become clearer as the present description continues, the frames may be arranged in levels based on priority. Illustratively, a first priority level is the highest priority level; a second priority level is the next highest priority level; and a third priority level is the lowest priority level. It is emphasized that the use of three priority levels is merely illustrative, and more than three levels may be used. Moreover, the priority levels may be further categorized by temporal intervals.

The first priority level includes packets containing compressed data of intra-coded video frames or video object plane (IVOP or I frame). For example, the I1 frame 101 includes the intra-coded video data of a frame at a particular instant of time. As represented by the time axis in FIG. 1, frame 101 is an initial frame of a first Group of Picture (GOP) single-layer content coded video stream.

The second priority level of the example embodiment includes prediction coded video frames or VOP (PVOP) coded video frames. For example, a P1 frame 102 is in this second priority level. As is known, compared to I1 frame 101, the P1 frame 102 includes only additional information (e.g. non-static video data). To this end, the P1 frame 102 does not include redundant video information. Thus, the P1 frame 102 includes motion in the video not found in the video frame of I1 101. Moreover, the P1 frame 101 depends on the I1 frame as a reference frame, as the I1 frame is used to predict the P1 frame. As is known, the frame from which a subsequent frame depends is required for video reconstruction upon decoding at a receiver.

Similarly, a P2 frame 103 is in the second priority level of the example embodiment, and includes additional data (e.g., non-static video data) not contained in P1 frame 101; and a P3 frame 104 is in the second priority level, and includes additional data (e.g. non-static video data) not contained in the P2 frame 103. Clearly, the P2 frame 103 depends from the P1 frame 102 and the P3 frame 104 depends from the P2 frame 103.

The third priority level includes bidirectional prediction coded video frames or video object plane (BVOP). These frames depend from both the I1 frame and the P2 and P3 frames. For example, the B1 frame 105 depends from the P2 frame and the P1 frame. Similarly, B frames 106-110 selectively depend from the I1, P1, P2, and P3 as shown by the arrows from one frame to another. For example, frames B3 and B4 depend from the P1 frame and the P2 frame directly and from the I1 frame indirectly. As such, the B3 frame has additional data (e.g. non-static information) relative to a combination of the P1 and P2 frames.

From the above description of an example embodiment, and as indicated by the arrows, the higher priority level frames are used to predict the frames of the lower priority levels of the first GOP.

A second intra-coded frame I2 111 begins a second GOP single-layer content coded video stream. This second GOP frame is later in time than the first GOP as indicated by the time axis shown. Similar to the I1 frame, the second I2 frame is in the first priority level, and all prediction frames and bidirectional prediction frames in the second and third priority levels depend from this reference frame. Thus, he higher priority level frames are used to predict the frames of the lower priority levels of the first GOP.

It is noted that each frame includes packetized video data. There may be one or more video network packets in a frame, or more than one frame may be comprised of one video network packet. For example, the I1 frame 101 may include two video packets; the P2 frame 103 may include one packet; and the B1 frame 105 and the B2 frame 106 may be comprised of a single packet. Accordingly, the I frames have the most data; the P frames have fewer data than the I frames, and the B frames have the least data.

As can be appreciated, if a higher priority frame is lost because of a bandwidth constraint, or other factor, those frames that depend from the lost higher priority frame cannot be motion-compensated when decoding in the receiver and the state of the video remains at the temporal level of the last priority frame that has not been dropped. In the extreme example, if the I1 frame were dropped, it is not possible to reconstruct the video at the receiver and either indiscernible video is compiled using the P1, P2 and B1-B6 frames; or the viewing screen is intentionally left blank; or the viewing screen shows the last reconstructed image.

Contrastingly, if a B frame of the third priority level is dropped, because there are no frames that depend from the B frame, the only loss is in temporal resolution, and not a lapse in the video. For example, if the B1 frame 105 and the B2 frame are dropped, the video image is that of the P1 frame. All motion subsequent to the P1 frame (in frames that depend from the to the P1 frames) is lost. Accordingly, in the present dependency tree, I frames are the most essential frames, the P-frames are the next-most essential and the B-frames are the least essential for motion-compensation and, subsequently, video reconstruction.

In order to mitigate the potential loss of video or video quality, example embodiments include a selective priority level-based dropping of frames of streaming video to increase the likelihood that layers of higher priority are transmitted through the degraded channel. The dropping of frames from lowest priority to highest priority is effected in accordance with the available bandwidth of the channel. While the dropping of streaming video frames may result in lower temporal resolution of the resultant video, the methods of the example embodiments provide an improved video quality in reduced bandwidth networks compared to known methods. Some illustrative frame dropping strategies are described presently.

FIG. 2 is a schematic representation of a dependency tree of single-layer content coded video in accordance with an example embodiment. In the present example embodiment, the prioritization is based on the VOP type. In particular, a first priority level L0 201 includes the IVOP frames, I1 202 and I2 203; a second priority level 204 includes the P frames, P1 205, P2 206, P3 207 and P 208; and a third priority level 209 includes the B frames, B1 210 through B10 219 as shown.

The prioritization scheme of the example embodiment is used to determine the order of dropping of frames in the event that the bandwidth of a wireless medium will not support the bandwidth requirements of the GOP. In general, the illustrative method mandates that a frame is not dropped until all frames that depend on the frame are dropped. As such, lapses of frames in the chain of dependent frames are substantially avoided, which reduces video quality loss. Thus, while the temporal resolution of a video stream may be reduced, the complete loss of the video is substantially avoided. The prioritization based dependency and dropping of an example embodiment are described presently.

As described previously, the I frames are the more essential to the video stream than P frames; and the P frames are more essential than B frames. Thus the non-scalable (single-layer content coded video) bitstream can be arranged with frames in three priority levels based on the VOP types. If a bandwidth limitation of the first stream (commencing with I1) mandates a dropping of frames, the method of the present illustrative embodiment requires the dropping of frames based on dependency. To this end, the frames that have no frames dependent therefrom (the B VOPs) are dropped first.

Next, the frames with fewer frames dependent thereon are dropped next. Illustratively, the P frames are dropped next. Moreover, there is a sub-priority consideration in the dropping of P frames. To with, the P3 frame 207, having fewer frames dependent thereon than the P2 frame 206 is dropped before the P2 frames. Stated differently, the P frames of the second priority level L1 204 of the example embodiment have a serial dependence shown by the arrows. As such, a frame is not dropped until all frames that depend on the frame are dropped. For example, the P2 frame 206 is not dropped until frames B3 212 through B6 215 and P3 frame 207 are dropped. As we know, the GOP structure is repeated throughout the entire MPEG bitstream. Thus the original MPEG bitstream displays some degree of periodicity.

FIG. 3 is another prioritization scheme based on dependency of the frames in accordance with another example embodiment. The prioritization method of the present example embodiment includes common features with features described in connection with the example embodiment of FIG. 2. Wherever practical, common features are not repeated so as to avoid obscuring the description of the example embodiments.

As referenced previously, the method of prioritization based on dependency of the example embodiments, a frame is not dropped until all frames that depend on the frame are dropped. In the present example embodiment, dependency among frames of the same type is addressed. For example, because some P frames depend on other P frames, the prioritization of the levels must include prioritizing the P frames to exploit this type of dependency. This may be referred to as an inter-frame dependency. Of course, the prioritization based on the inter-frame dependency of the P frames is chosen merely to illustrate this prioritization method. Clearly, other frames may be similarly prioritized.

The GOPs of the video stream of the example embodiment of FIG. 3 are arranged a first priority level L0 301, a second priority level L1 302, a third priority level L2 303, a fourth priority level L3 304 and a fifth priority level L4 305. Within each priority level are frames, which are located in their respective levels based on their relative importance. The first level L0 301 includes the most important frames; in this case I1 frame 306 and I2 frame 307. The second level L1 302 includes P1 frame 308 and P frame 309. The third level L2 includes P2 frame 310, which depend from P1 frame 308. The fourth level L3 304 includes P3 frame 311, which depends from the P2 frame 310; and the fifth level L4 305 includes B1 frame 312 through B frame 321.

According to the present example embodiment, the frames of the fifth priority level L4 305 are dropped first, followed by those in the fourth priority level L3 304, and so forth. Beneficially, the frames are assigned to a priority level based on their dependence on frames in higher priority. In this manner, a prioritization for dropping frames of the same type is provided.

FIG. 4 is a schematic diagram of a temporal prioritization scheme with a constant frame interval in accordance with an example embodiment. As will become clearer as the present description continues, in the present example embodiment, the priority levels are also categorized by temporal intervals.

In the example embodiment described in connection with FIG. 4, the periodic property of the original GOP is exploited. To this end, it may be useful to preserve the periodicity for each individual layer to simplify the system design. For example, in dependency prioritization scheme such as described in connection with FIGS. 2 and 3, the priority levels that contain I, P frames are periodic with all the VOP transmitted evenly in each individual level. However, the priority level that contains only the B VOPs are not periodic, which complicates the system design. To this end, in the example embodiment of FIG. 2, it is clear that the B1 frame 210 and the B2 frame 211 lag temporally behind the P2 frame. By further partitioning the B VOPs within each P period into multiple layers according to location along the time axis, full periodicity can be achieved.

In the example embodiment of FIG. 4, the are six priority levels: a first priority level L0 401, a second priority level L1 402, a third priority level L2 403, a fourth priority level L3 404, a fifth priority level L4 405 and a sixth priority level L5 406. The first priority 401 includes frames I1 407 and I2 408; the second priority level 402 include frames P1 409 and P 410; the third level 403 includes frame P2 411; the fourth frame 404 includes frames P3 412; the fifth frame includes frames B1 413, B3 414, B5 415, B7 416 and B 417; and the sixth level includes frames B2 418, B4 419, B6 420, B8 421 and B 422.

Thus, the B frames are temporally prioritized. For example B1 and B2 are in the same P period of (P1, I1); and B3 and B4 are in the same P period of (P1, P2). Hence, by partitioning B2, B4, B6, B7 into the sixth priority level, full periodicity of each layer is achieved.

As with previous example embodiments, the frames are dropped by their priority level, with frames of the lowest level (L5 406) dropped first and the frames of the highest level (L0 401) dropped last. In this manner temporal prioritization may be used to significantly reduce the degradation due to dropped frames when dropping is necessary.

The example embodiment of FIG. 4 is intended to be illustrative. Clearly, the concepts of this embodiment can be expanded. For video coded with MPEG employing a GOP structure of (m, n) and constant frame rate f, (m is the number of frames in a GOP; while n is the number of frames in a P period), the number of P period in the GOP is:

$$p = \frac{m}{n} ;$$

the number of layers generated using constant-interval layering scheme is:

L=p+n−1;

and the resulting constant frame rate fr for layer l is:

$$fr ( l ) = \{ \begin{matrix}\frac{f}{m} , for l ∈ [ 0 , p ) \\ \frac{f}{p} , for l ∈ [ p , p + n - 1 )\end{matrix}$$

In accordance with an example embodiment, in order to facilitate adaptive or prioritized transmission of the different priority levels, which will be carried in multiple transports, labeling of the packets and assigning the packets to a level using transport layer identification is effected.

Employing any of the previously described example embodiments, the non-scalable video content can be assigned to multiple priority levels. Thus a generic temporal scalability can be established this way with minimum complexity. This temporal scalability established is illustratively for MPEG-coded content and facilitates the priority-oriented streaming strategy. When encountering channel degradation, the layers with lower priorities can be dropped according to the available bandwidth to increase the chance that the layers with higher priority get through the degraded channel. This streaming strategy is usually referred to as priority-based dropping. Because the video content is assigned to a priority level according to the dependency, by using the priority-based dropping, the VOPs are dropped before their reference VOPs. This way the severe quality loss caused by prediction drift can be significantly reduced if not substantially eliminated.

FIG. 5 is a schematic diagram depicting an illustrative streaming system 500 using Real-time Transport Protocol (RTP)/IP transport. Each one of the priority levels described previously may be carried in one RTP session forming a virtual channel to facilitate adaptation. This generic multi-channel streaming architecture allows various schemes of adaption algorithms. These include, but are not limited to: server-driven adaptation, receiver-driven adaptation, and/or via lower layer QoS provisioning such as Mac Qos provided with Wi-Fi WLAN products.

Illustratively, the architecture of the streaming system 500 comprises of a media server 501 (e.g., may be co-located with an access point of a wireless network), an IP network, and at least one media client 502 (e.g., wireless stations). The video frames are transmitted by a transmitter 503 of the media server 501 to a receiver(s) 504 at the media client(s) in an on-demand manner. An encoder 505 encodes the video frames as referenced previously and provided the frames to the transmitter 503. It is noted that using similar components and methods, the client 502 may transmit video data to the server 501; or to other clients 502 either directly or via the server.

In the illustrative system 500, the receiver 503 is illustratively a prioritized multi-level receiver with single layer decoder 505. Using known techniques, the depacketized bitstream is first multiplexed to the corresponding decoder DEC 506 based on its frame type for decoding. Reference frames are stored after reconstruction and used in motion compensation for the construction of other frames that depend on them. The decoded/reconstructed frames are ordered according to their display order and sent to renderer (not shown) via a multiplexer (not shown).

In accordance with an example embodiment, the dropping of frames that may be necessary in a network due to bandwidth considerations may be effected by dropping levels from lowest priority to highest priority as described previously. Illustratively, a lower networking layer such as a MAC layer of the server 501 drops the selected packets using prioritized dropping methods of the example embodiment and according to their transport id/or labeling. As such, a selected frames or an entire level may be dropped for a period of time. If, in time, channel conditions improve to allow more levels to be transmitted, the dropped level may be added back.

It is contemplated that the various methods, devices and networks described in conjunction with transmitting video data of the example embodiments can be implemented in hardware and software. It is emphasized that the various methods, devices and parameters are included by way of example only and not in any limiting sense. In view of this disclosure, those skilled in the art can implement the various example methods, devices and networks in determining their own techniques and needed equipment to effect these techniques, while remaining within the scope of the appended claims.

1. A method of video communication, the method comprising:
providing single layer content coded video frames (101-111);
selectively assigning each of the frames to one of a plurality of levels (201, 204, 209); and
based on bandwidth limitations, selectively transmitting some or all of the frames based on their level.

2. A method as recited in claim 1, wherein the selective assigning further comprises establishing a priority for each of the plurality of levels.

3. A method as recited in claim 2, wherein the priority levels are based on a dependency of frames on other frames.

4. A method as recited in claim 2, wherein a frame in a higher priority level is dropped after a frame in a lower priority level that depends on the frame in the higher priority level is dropped.

5. A method as recited in claim 2, wherein the priority of the levels is based on a periodicity of the frames.

6. A method as recited in claim 5, wherein the priority of levels substantially preserves the periodicity of the frames.

7. A method as recited in claim 2, wherein the transmitting further comprises dropping certain frames based on the bandwidth considerations and wherein none of the certain frames frame is dropped until all frames that depend on the certain frames are dropped.

8. A method as recited in claim 7, wherein a highest priority level includes packets in an intra video object plane (IVOP), a lower priority level includes packets in a prediction video object plane (PVOP) and a lowest priority level includes packets in a bidirectional prediction video object plane (BVOP).

9. A method as recited in claim 8, wherein method further comprises partitioning the PVOPs within a group of picture (GOP) into certain levels of the plurality of levels based on an inter-frame dependency.

10. A method as recited in claim 1, wherein the method further comprising:
providing a receiver (504) with a single layer decoder (506);
decoding the single-layer content video packets; and
reconstructing the video.

11. A method as recited in claim 1, wherein the communication is wireless.

12. A method as recited in claim 1, wherein the plurality of priority levels is also categorized by temporal intervals.

13. A communication link (500), comprising:
a transmitter (503);
a receiver (504); and
an encoder (505) connected to the transmitter, wherein the encoder is adapted to encode video signals into a plurality of single layer content coded video frames, and the encoder is adapted to assign each of the video frames to one of a plurality of levels (201, 204, 209).

14. A communication link as recited in claim 13, wherein the link is a wireless link.

15. A communication link as recited in claim 14, wherein based on bandwidth limitations of the link, the transmitter selectively transmits some or all of the frames based on their level.

16. A communication link as recited in claim 13, further comprising a decoder (506), which decodes the single-layer content video frames.

17. A communication link as recited in claim 13, wherein the plurality of levels are prioritized.

18. A communication link as recited in claim 17, wherein a highest priority level includes packets in an intra video object plane (IVOP), a lower priority level includes packets in a prediction video object plane (PVOP) and a lowest priority level includes packets in a bidirectional prediction video object plane (BVOP).

19. A communication link as recited in claim 17, wherein the PVOPs within a group of pictures (GOP) are further partitioned into multiple priority-levels based on an inter-frame dependency.

20. A communication link as recited in claim 17, wherein the plurality of priority levels is categorized by temporal intervals.

21. A communication link as recited in claim 17, wherein the priority of levels substantially preserves a periodicity of the frames.

22. A communication link as recited in claim 15, wherein the transmitter drops certain frames based on the bandwidth considerations and wherein none of the certain frames frame is dropped until all frames that depend on the certain frames are dropped.
